(19) United States
(12) Patent Application Publication
(10) Pub. No.: US 2020/0271838 A1
(43) Pub. Date: Aug. 27, 2020

(54) Polarizer, Wavelength Filter and Waveplate

(71) Applicant: Moxtek, Inc., Orem, UT (US)

(72) Inventors: Liang Gao, Draper, UT (US); Eric Gardner, Eagle Mountain, UT (US)

(21) Appl. No.: 16/774,196

(22) Filed: Jan. 28, 2020

Related U.S. Application Data
(60) Provisional application No. 62/810,506, filed on Feb. 26, 2019.

(51) Int. Cl. G02B 5/20; G02B 5/30

(52) U.S. Cl. CPC G02B 5/20; G02B 5/3025; G02B 5/3083

(57) ABSTRACT

An optical device can comprise a subassembly with at least two different optical components in a stack. Each optical component can be a wavelength filter, a polarizer, or a waveplate. This stack can be a subassembly which can be manufactured separately from other components like CCD, CMOS, liquid crystal layer, electronic components, and electrodes. Consequently, this subassembly can be manufactured relatively inexpensively and with large variety of configurations. After first manufacturing the subassembly, it can then be attached to other components (e.g. CCD, CMOS, liquid crystal layer, electronic components, electrodes, etc.) to form the completed device (e.g. optical display, radiation detection, radiation measurement, imaging, etc.).

### CLAIM OF PRIORITY

This application claims priority to U.S. Provisional Patent Application No. 62/810,506, filed on Feb. 26, 2019, which is incorporated herein by reference.

### FIELD OF THE INVENTION

The present application is related generally to optical filters.

### BACKGROUND

Optical display, radiation detection, and imaging devices can include a stack of some of the following components: charge-coupled device (CCD) image sensor, complementary metal oxide semiconductor (CMOS) Image sensor, a liquid crystal layer, electronic components, electrodes, and optical components. For example, see patent publications U.S. Pat. Nos. 6,977,702; 8,199,282; 8,934,069; WO2012053753; WO2012053754; and WO2018190049.

These devices can be manufactured together by successively adding layers of different components in a single stack. Typical manufacturing of such devices is adapted to large volumes of a single design. A problem is that it can be expensive to vary components in the design. It would be beneficial to be able to customize by changing certain components to meet the needs of the many different applications of such devices.

Another problem of the present manufacturing process is that a defect in one component in the stack can destroy the functionality of the entire stack. Therefore, manufacturing yield can be a big concern.

### SUMMARY

It has been recognized that it would be advantageous to improve the manufacturing, and the ability to vary the design, of optical display, radiation detection, radiation measurement, and imaging devices, and other similar devices. The present invention is directed to a subassembly with at least two different optical components in a stack. Each optical component can be a wavelength filter, a polarizer, or a waveplate.

In one embodiment, each of the optical components can include separate pixels. In another embodiment, the stack can be free of radiation detection devices, liquid crystal, electronic components, or electrodes. In another embodiment, a thickness of the stack can be ≥0.1 mm and ≤3 mm.

This subassembly (i.e. stack of optical components) can be manufactured separately from other components like CCD, CMOS, liquid crystal layer, electronic components, and electrodes. Consequently, this subassembly can be manufactured relatively inexpensively and with large variety of configurations. After first manufacturing the subassembly, it can then be attached to other components (e.g. CCD, CMOS, liquid crystal layer, electronic components, electrodes, etc.) to form the completed device (e.g. optical display, radiation detection, radiation measurement, imaging, etc.).

### BRIEF DESCRIPTION OF THE DRAWINGS

### Drawings Might not be Drawn to Scale

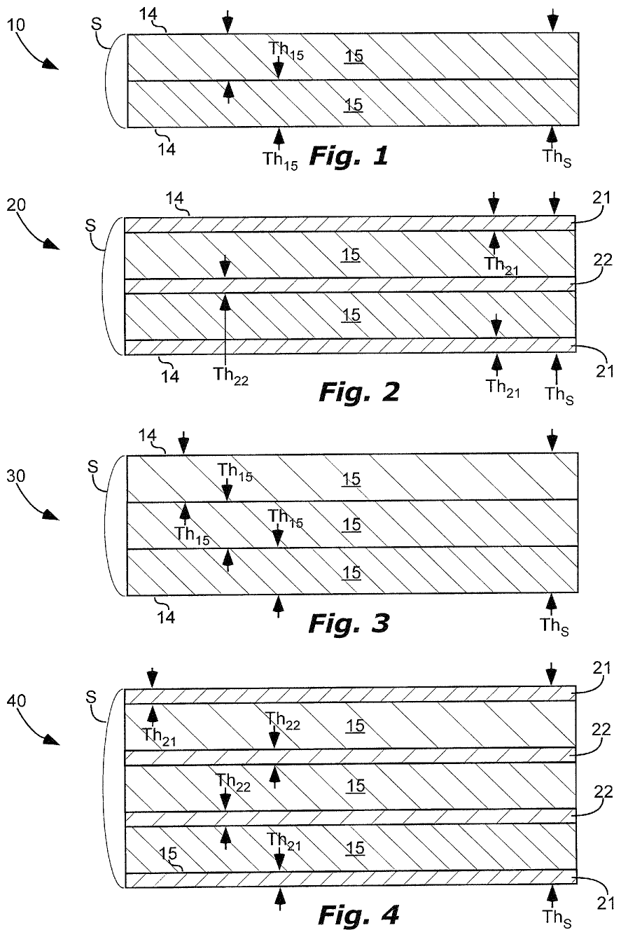

FIG. 1 is a schematic, cross-sectional side-view of an optical device 10 comprising two different optical components 15 adjoining each other in a stack S, each of the two different optical components 15 being a wavelength filter, a polarizer, or a waveplate, in accordance with an embodiment of the present invention.

FIG. 2 is a schematic, cross-sectional side-view of an optical device 20 comprising (i) two different optical components 15 in a stack S, each of the two different optical components 15 being a wavelength filter, a polarizer, or a waveplate; (ii) inner solid layers 22 between adjacent optical components 15; (ill) and outer solid layers 21 at outer sides of the stack S; in accordance with an embodiment of the present invention.

FIG. 3 is a schematic, cross-sectional side-view of an optical device 30 comprising three different optical components 15 adjoining each other in a stack S, each of the three different optical components 15 being a wavelength filter, a polarizer, or a waveplate, in accordance with an embodiment of the present invention.

FIG. 4 is a schematic, cross-sectional side-view of an optical device 40 comprising (I) three different optical components 15 in a stack S, each of the three different optical components 15 being a wavelength filter, a polarizer, or a waveplate; (ii) inner solid layers 22 between adjacent optical components 15; (iii) and outer solid layers 21 at outer sides of the stack S; in accordance with an embodiment of the present invention.

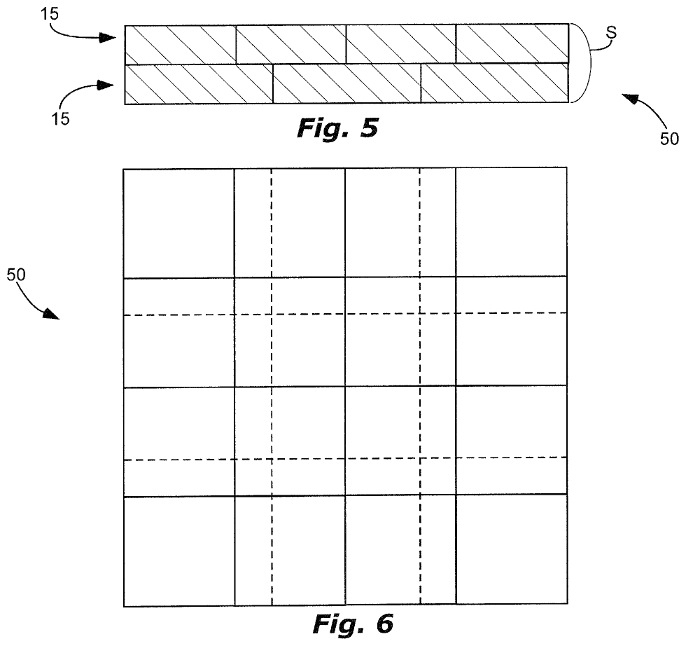

FIG. 5 is a schematic, cross-sectional side-view of optical device 50, similar to optical devices 10 or 20, but each of the optical components 15 including separate pixels, pixels of one of the optical components 15 having different dimensions than pixels of the other of the optical components 15, in accordance with an embodiment of the present invention.

FIG. 6 is a schematic top-view of optical device 50 with dotted lines showing different pixels of the lower optical component 15, in accordance with an embodiment of the present invention.

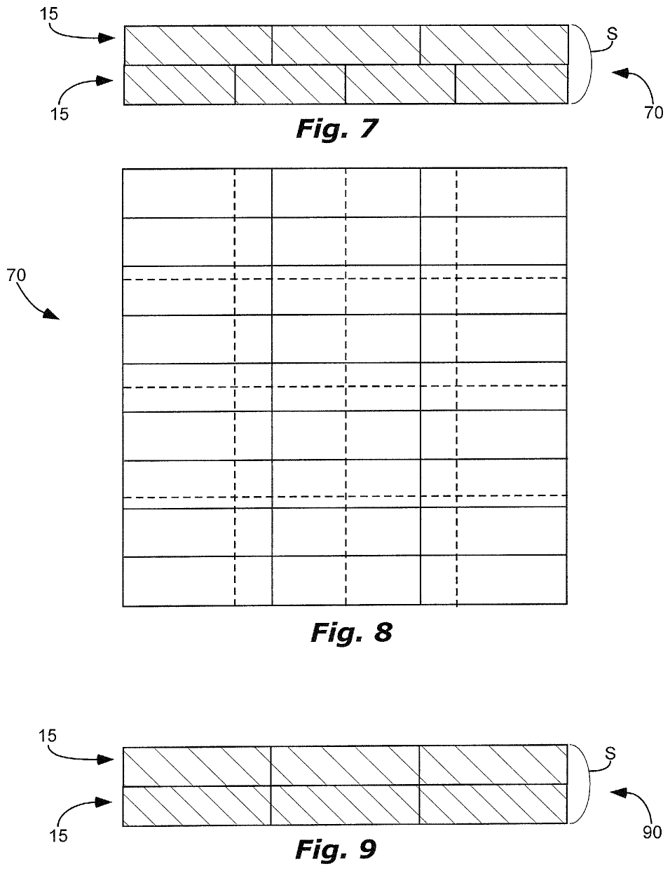

FIG. 7 is a schematic, cross-sectional side-view of optical device 70, similar to optical devices 10 or 20, but each of the optical components 15 including separate pixels, pixels of one of the optical components 15 having different dimensions than pixels of the other of the optical components 15, in accordance with an embodiment of the present invention.

FIG. 8 is a schematic top-view of optical device 70 with dotted lines showing different pixels of the lower optical component 15, in accordance with an embodiment of the present invention.

FIG. 9 is a schematic, cross-sectional side-view of optical device 90, similar to optical devices 10 or 20, but each of the optical components 15 including separate pixels, pixels of both of the optical components 15 having equal dimensions, in accordance with an embodiment of the present invention.

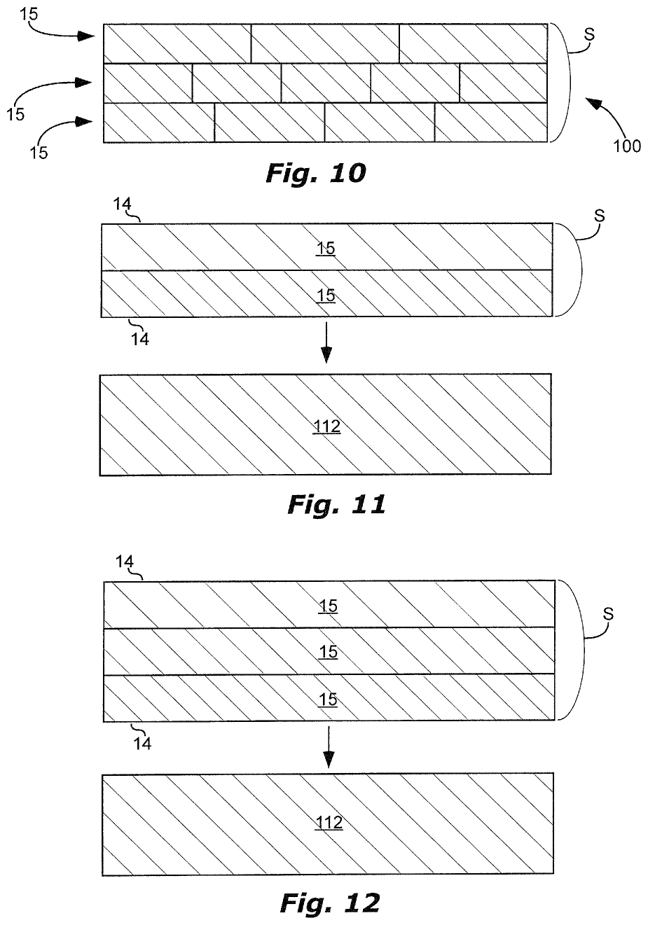

FIG. 10 is a schematic, cross-sectional side-view of optical device 100, similar to optical devices 30 or 40, but each of the optical components 15 including separate pixels, pixels of one or all of the optical components 15 having different dimensions than pixels of the other optical components 15, in accordance with an embodiment of the present invention.

FIGS. 11-12 are schematic, cross-sectional side-views of methods of making an optical assembly, the methods comprising (i) making an optical device including a stack S of two or three of the following: a wavelength filter, a polarizer, and a waveplate; then (ii) attaching the optical device to a component 112 (a radiation detection device, liquid crystal, an electronic component, an electrode, or combinations thereof).

### DEFINITIONS

As used herein, the term “nm” means nanometer(s), the term “μm” means micrometer(s), and the term “mm” means millimeter(s).

As used herein, the term “adjoin” means direct and immediate contact; and the term “adjacent” includes adjoin, but also includes near or next to with other solid material(s) between the adjacent items.

As used herein, the terms “equal in size” and “equal dimensions” mean exactly equal in size or dimension, equal in size or dimension within normal manufacturing tolerances, or nearly equal in size or dimension, such that any deviation from exactly equal would have negligible effect for ordinary use of the device.

As used herein, the term “pixels” means different regions of an optical device with intentionally different optical properties.

### DETAILED DESCRIPTION

As Illustrated in FIGS. 1-2, optical devices 10 and 20 are shown comprising two different optical components 15 adjoining each other in a stack S. As illustrated in FIGS. 3-4, optical devices 30 and 40 are shown comprising three different optical components 15 in a stack S.

The optical devices 10, 20, 30, and 40 can consist essentially of two (FIGS. 1-2) or all three (FIGS. 3-4) of the following optical components 15 in a stack S: a wavelength filter, a polarizer, and a waveplate. The optical components 15 can be combined in any order.

The wavelength filter can be designed to block or pass certain range(s) of the electromagnetic spectrum. The polarizer can be any type of polarizer, including an array of parallel, elongated wires, a metamaterial polarizer, a film polarizer, or combinations thereof. The waveplate can alter polarization state, such as for example by converting between linearly polarized light and circularly polarized light. Examples of thicknesses Th₁₅ of each of the optical components 15 includes ≥50 nm or ≥300 nm and ≤1 μm, ≤3 μm, ≤500 μm, or ≤1 mm.

The stack S can be free of radiation detection devices, liquid crystal, electronic components, or electrodes. Due to absence of such additional devices, a thickness Thₛ of the stack can be relatively thin, such as for example ≥0.1 mm, ≥0.25 mm, or ≥0.4 mm and ≤0.8 mm, ≤1 mm, ≤2 mm, ≤3 mm, ≤5 mm, or ≤10 mm. The thickness Thₛ can be measured perpendicular to adjacent faces of optical components 15.

Opposite, outer sides 14 of the stack S can be exposed to air. As illustrated in FIGS. 1 and 3, the optical components 15 can be located at opposite, outer sides 14 of the stack S. As illustrated in FIGS. 2 and 4, the stack can include other layers, such as for example a substrate or optical thin films. These other layers can be outer solid layers 21 at opposite, outer sides of the stack S, or inner solid layers 22 between adjacent optical components 15.

The outer solid layers 21 can be relatively thin, and a distance from each of the outer sides 14 to the optical components 15 (i.e. thickness Th₂₁ of the outer solid layers 21) can be small. A thickness Th₂₂ of the inner solid layers 22, and thus also distance between adjacent optical components 15, can also be small. These thicknesses Th₂₁ and Th₂₂ can be, for example, ≥0.1 nm, ≥1 nm, or ≥20 mm and ≤100 nm, ≤500 nm, ≤1 μm, or ≤5 μm. A choice of whether to include outer solid layers 21 and inner solid layers 22 can be made based on various factors, such as for example ease of manufacture, material cost, adhesion of the layers, protection of the optical device, and optical performance.

As Illustrated in FIGS. 5-10, the optical components 15 of optical devices 50, 70, 90, and 100 can include separate pixels. Although not shown in the figures, one of two, one of three, or two of three of the optical components 15 can include separate pixels. Optical devices 50, 70, 90, and 100 can have properties of optical devices 10, 20, 30, or 40, but also with the added feature of pixels.

The pixels can be used for image formation and analysis. The polarizer can include pixels with different polarization, such as for example wire angle, wire material, coating on wires, layers of wires, wire cross-sectional shape, wire width, wire height, or combinations thereof. These differences of polarization are described in U.S. Pat. No. 8,873,144. The wavelength filter can include separate pixels, each pixel having a difference in wavelength filtration range with respect to at least one other pixel. The waveplate can include separate pixels, each pixel having a difference in polarization properties. Each pixel can have a difference with respect to ≥1, ≥2, ≥3, or ≥4 other pixels in its optical component 15.

As illustrated in FIGS. 5-6, the pixels of one optical component 15 can be smaller than pixels of the other optical component 15. For example, a surface area of a pixel in one optical component 15 can be ≤30%, ≤60%, or ≤90% of a surface area of a pixel in the other optical component 15. Any of the optical components 15 (wavelength filter, polarizer, or waveplate) can be smaller/larger. A choice between these designs can depend on manufacturing cost and needed polarization and wavelength filtration resolution.

As illustrated in FIGS. 7-8, the pixels of one optical component 15 can be smaller in one direction but larger in another direction than pixels of the other optical component 15. As illustrated in FIG. 9, the pixels of one optical component 15 can be equal in size to pixels of the other optical component 15. Although not shown in the figures, the pixels of two of the three or all three optical components 15 can be equal in size with respect to each other. As illustrated in FIG. 10, the pixels of each of the three optical components 15 can be a different size with respect to each other.

The subassembly described above (i.e. stack S of optical components) can be manufactured separately from other components like CCD, CMOS, liquid crystal layer, electronic components, and electrodes. Consequently, this subassembly can be manufactured relatively inexpensively and with large variety of configurations. After first manufacturing the subassembly, it can then be attached to other components (e.g. CCD, CMOS, liquid crystal layer, electronic components, electrodes, etc.) to form the completed device (e.g. optical display, radiation detection, radiation measurement, imaging, etc.).

As illustrated in FIGS. 11-12, a method of making an optical assembly can comprise making an optical device including a stack S of two or three of the following: a wavelength filter, a polarizer, and a waveplate; then attaching the optical device to a component 112 (a radiation detection device, liquid crystal, an electronic component, an electrode, or combinations thereof). Many methods can be used for attaching the optical device to the component 112, including adhesive (e.g. pressure sensitive, UV cure, heat cure, time cure) or optical bonding as described in U.S. Pat. Nos. 6,284,085 and 6,548,176.

The optical device can have properties according to any combination of the embodiments described herein. The stack S can include more than three of the optical components 15 or can include additional layers, such as for example the inner solid layer(s) 22, the outer solid layer(s) 21, or both.

This separate manufacturing, then later combining, allows for a much larger variety of final optical assemblies. It can be relatively easy to vary the design of the optical device, which can then be matched with the radiation detection device, liquid crystal, electronic component, electrode, etc. A further advantage is that yield can be improved by manufacturing these devices separately, then later combining them.

What is claimed is:

1. An optical device comprising:
two different optical components in a stack, each of the two different optical components being a wavelength filter, a polarizer, or a waveplate;
each of the optical components includes separate pixels;
the stack is free of radiation detection devices, liquid crystal, electronic components, and electrodes; and
a thickness of the stack is ≥0.1 mm and ≤3 mm.

2. The optical device of claim 1, wherein the two different optical components consist essentially of a polarizer and a wavelength filter.

3. The optical device of claim 1, wherein a maximum separation between the two different optical components is ≤1 μm.

4. The optical device of claim 1, wherein the two different optical components are separated from each other by a solid material with a thickness of ≥0.1 nm and ≤5 μm.

5. The optical device of claim 1, wherein the two different optical components adjoin each other.

6. The optical device of claim 1, wherein the stack has two opposite, outer sides exposed to air and a distance from each of the two opposite, outer sides to the two different optical components is ≤5 μm.

7. The optical device of claim 1, wherein the two different optical components are located at opposite, outer sides of the stack and are each exposed to air.

8. The optical device of claim 1, further comprising all three of the optical components in the stack.

9. A method of manufacturing an optical assembly with the optical device of claim 1, the method comprising the following steps in the following order:
obtaining the optical device; then
affixing the optical device to a radiation detection device, liquid crystal, an electronic component, an electrode, or combinations thereof.

10. An optical device comprising:
two different optical components in a stack, each of the two different optical components being a wavelength filter, a polarizer, or a waveplate; and
the stack is free of radiation detection devices, liquid crystal, electronic components, and electrodes.

11. The optical device of claim 10, wherein the two different optical components consist essentially of a polarizer and a wavelength filter.

12. The optical device of claim 10, further comprising all three of the optical components in the stack.

13. The optical device of claim 10, wherein each of the two different optical components includes separate pixels.

14. The optical device of claim 13, further comprising a different pixel size between the two different optical components such that a surface area of a pixel in one of the two different optical components is ≤60% of a surface area of a pixel in the other of the two different optical components.

15. An optical device comprising:
two different optical components in a stack, each of the two different optical components being a wavelength filter, a polarizer, or a waveplate;
the stack has two opposite, outer sides exposed to air; and
a thickness of the stack is ≥0.1 mm and ≤3 mm.

16. The optical device of claim 15, wherein the two different optical components consist essentially of a polarizer and a wavelength filter.

17. The optical device of claim 15, further comprising all three of the optical components in the stack.

18. The optical device of claim 15, wherein a distance from each of the two opposite, outer sides to the two different optical components is ≤5 μm.

19. The optical device of claim 15, wherein each of the two different optical components includes separate pixels.

20. The optical device of claim 19, further comprising a different pixel size between the two different optical components such that a surface area of a pixel in one of the two different optical components is ≤60% of a surface area of a pixel in the other of the two different optical components.
